(19) United States
(12) Patent Application Publication
(10) Pub. No.: US 2025/0385577 A1
(43) Pub. Date: Dec. 18, 2025

(54) METHOD OF AND APPARATUS FOR FITTING A SLEEVE TO A ROTOR

(71) Applicant: Magnomatics Limited, Sheffield (GB)

(72) Inventors: Jeffrey George Birchall, Sheffield (GB); Gregg Stephen Wilson, Sheffield (GB); Sarah Duggan, Sheffield (GB); Tapiwanashe Lawrence Mandishona, Sheffield (GB); Glynn Cooke, Sheffield (GB); Stuart David Calverley, Sheffield (GB)

(21) Appl. No.: 19/240,339

(22) Filed: Jun. 17, 2025

(30) Foreign Application Priority Data
Jun. 18, 2024 (GB) 2408766.0

(51) Int. Cl. H02K 15/035; H02K 1/27

(52) U.S. Cl. CPC H02K 15/035; H02K 1/27; H02K 2215/00

(57) ABSTRACT

Systems and methods for fitting a sleeve to a rotor. The method includes fitting a seal to a first end of the sleeve portion to create a fluid-tight seal between the sleeve portion and that seal, introducing fluid into the sleeve portion, axially moving the rotor inside the sleeve portion towards the first end, and increasing the pressure of the fluid in the sleeve portion to radially expand the sleeve portion and thereby accommodate the rotor within the sleeve portion as it moves towards the first end. The apparatus includes a sleeve having a sleeve portion, a rotor, and a seal at a first end of the sleeve portion. The seal at the first end creates a fluid-tight seal. An interference fit may exist between the rotor and the sleeve portion such that the sleeve portion radially supports magnets on the rotor when it is fitted around the rotor.

### RELATED APPLICATION

This application claims priority to U.K. Patent Application No. 2408766.0, filed Jun. 18, 2024, the disclosure of which is incorporated herein by reference in its entirety.

### TECHNICAL FIELD

This disclosure relates to a method of and apparatus for fitting a sleeve to a rotor, such as a rotor for use in an electrical machine.

### BACKGROUND

In radial-flux permanent magnet electrical machines, the magnets are often mounted around the radially outer surface of the rotor. At high rotational speeds of the rotor, the magnets are subject to high centripetal forces. Using only an adhesive to fix the magnets to the rotor may not be enough to withstand those forces, such that the adhesive may fail causing one or more magnets to detach from the rotor. This may in turn lead to failure of the electrical machine.

To avoid the permanent magnets becoming detached in this way, a tube-shaped sleeve can be fitted around the magnets mounted on the rotor. Material choice for the sleeve is important. Using an electrically conductive material or a magnetisable material would result in eddy current losses or other losses in the sleeve and so this is disadvantageous. This solution is therefore problematic.

Using a composite material comprising a glass fibre or carbon fibre is therefore preferred for forming the sleeve. One approach to forming the sleeve from a composite material is to wind a filament or tape of fibre directly onto the rotor to form the sleeve around the rotor. To ensure that the resulting sleeve provides radial support for the permanent magnets in the desired way, the fibres or tape must be wound tightly around the rotor. However, there is a limit above which tension in the fibre/tape during winding may damage tensioning or guiding equipment of the winding machine being used for this. Thus, it is challenging to achieve an adequate fit between a sleeve formed in this way on the rotor and so this solution is also problematic.

An alternative approach is to form a sleeve on a mandrel and then press-fit the formed sleeve to the rotor. Using this approach, it is possible to ensure a tight fit between the sleeve and the magnets such that the magnets are adequately supported in position on the rotor during use. However, press-fitting the sleeve in this way involves applying an axial force to the sleeve. This can become problematic for rotors with longer axial length as the size of the axial force needed for the press-fitting either exceeds the mechanical strength of the sleeve or requires a sleeve with a thickness that would undesirably increase the air-gap between the rotor and the stator, reducing performance of the electrical machine.

Attempts to address these problems with press-fitting a formed sleeve have included cutting the sleeve into several axially-shorter sleeve sections and press-fitting these individually to the rotor to be axially juxtaposed and distributed to cover the radially outer surface of the rotor. Unfortunately this is time consuming and can leave regions of the permanent magnets exposed if adjacent sleeve sections do not properly align. Also, due to wind angle and the need to develop the stress in the sleeve sections, an end region of lower stress exists at the axial end of each sleeve section. With multiple sleeve sections, rather than a single sleeve, the proportion of end regions to the overall length of the sleeve becomes significant and reduces the overall ability of the sleeve to withstand the centripetal forces. This solution is therefore also problematic.

A further solution exists in which a pre-formed sleeve of composite material has an axial expander plug press-fitted to each of its axial ends. The expander plugs are tapered to radially expand the end of the sleeve to which they are fitted. The sleeve, with the plugs fitted, is then placed in a hydraulic chamber. The rotor of the electrical machine to which the sleeve is to be fitted is also placed in the chamber, spaced from one end of the sleeve and co-axial with it. The hydraulic chamber is then operated to increase the pressure of fluid in the chamber and inside the sleeve to radially expand the sleeve. The rotor is then moved in an axial direction to first axially abut the adjacent one of the plugs and then push that plug axially through the sleeve in abutment with the rotor. Thus, the rotor is moved inside the sleeve along its axial length. This continues until the plug abutted by the rotor in turn abuts the plug at the other axial end and pushes that plug, together with the first plug, out of the sleeve. Thus, the rotor is located axially within the composite sleeve. The process ends with the hydraulic pressure in the chamber, and hence inside the sleeve, being reduced to achieve the desired interference fit between the rotor and the composite sleeve.

Disadvantages with this approach include, again, significant axial forces acting on ends of the sleeve, in this case through the expander plugs, which may deform the sleeve and/or require it to be of a thickness that undesirably increases the airgap between the rotor and the stator with which it will be paired. For example, even a 2 mm sleeve thickness would be undesirable. A further factor with this approach leading towards a disadvantageously thicker sleeve is the need to have an adequate seal between the expander plug and the end of sleeve to maintain the pressure differential for the hydraulic press to work. Furthermore, the forced movement of the expander plug through the inside of the sleeve to expand the sleeve may undesirably deform the sleeve. A further drawback is that the pressure in the apparatus must be controlled carefully during the fitting operation to avoid damage to the various components. As the curved outer surface of the sleeve is not supported during fitting, the sleeve may not remain concentric and round during the process. These various drawbacks also mean that it is not possible to know if an even airgap between the rotor and outer surface of the sleeve has been achieved.

It is therefore desirable to improve on the existing solutions described above.

### SUMMARY

According to an aspect of this invention, there is provided a method of fitting a sleeve portion around a rotor of an electrical machine to radially support magnets on the rotor in use, the sleeve portion being radially smaller than the rotor before that sleeve portion is fitted around the rotor, the method comprising: fitting a seal to a first end of the sleeve portion to create a fluid-tight seal between the sleeve portion and that seal; introducing fluid into the sleeve portion; axially moving the rotor inside the sleeve portion towards the first end; and increasing the pressure of the fluid in the sleeve portion to radially expand the sleeve portion and thereby accommodate the rotor within the sleeve portion as it moves towards the first end.

Increasing the pressure of the fluid in the sleeve portion may be done by pumping fluid into the sleeve portion. Increasing the pressure of the fluid may be done by the rotor axially moving towards the first end to reduce the volume between the rotor and the first end.

The method may comprise the fluid flowing between the outside of the rotor and the inside of the sleeve portion as the rotor is axially moved inside the sleeve portion towards the first end. This may have the effect of lubricating movement of the rotor relative to the sleeve portion, reducing friction and wear. This may have the effect of limiting pressure of the fluid in the sleeve portion between the rotor and the first end below a pressure at which the sleeve would fail.

The sleeve portion may be part of a sleeve that comprises a taper portion. The sleeve portion and the taper portion may be integrally formed with each other. The taper portion may taper from a smaller diameter end at the first end of the sleeve portion to a larger diameter end. The larger diameter end may be larger in diameter than the diameter of the rotor. In this way, the taper portion can act to guide the rotor when moved towards the sleeve portion through the taper portion. The method may comprise the step of axially moving the rotor through the taper portion towards the sleeve portion. The method may comprise the fluid flowing between the outside of the rotor and the inside of the taper portion as the rotor is axially moved inside the taper portion towards the sleeve portion. This may have the some or all of the effects noted above of the fluid flowing between the rotor and the inside of the sleeve portion.

The sleeve portion may be part of a sleeve that comprises a larger diameter portion. The larger diameter portion of the sleeve may extend from the larger diameter end of the taper portion away from the sleeve portion. All three portions of the sleeve may be integrally formed with each other. In an embodiment, the taper portion may be omitted and the larger diameter portion is joined to the sleeve portion by a radially extending annular portion between the two, in other words by a step rather than a taper. The larger diameter portion may be of larger diameter than the rotor. The rotor may be a clearance fit and/or a sliding fit in the larger diameter portion. The method may comprise axially moving the rotor inside the larger diameter portion of the sleeve towards the sleeve portion.

The method may comprise operating a hydraulic drive system to axially move the rotor. The method may comprise operating a hydraulic flow system to increase the pressure of the fluid in the sleeve portion. The method may also comprise operating the hydraulic flow system to cause the fluid to flow between the rotor and/or the sleeve portion and/or the taper portion and/or the larger diameter portion of the sleeve.

The method may comprise fitting a seal to an open end of the larger diameter portion to create a fluid-tight seal between that seal and the larger diameter portion. The method may comprise operating the hydraulic flow system to circulate fluid through the seal in the sleeve portion, through the sleeve portion, through the tapered portion, through the larger diameter portion, through the seal in the larger diameter portion and back through fluid conduit connecting the two seals to recirculate fluid around that path.

The method may comprise the fluid in the larger diameter portion being in fluid communication with a pressure relief valve to maintain the pressure in the larger diameter portion at a pressure higher than atmospheric pressure while keeping it lower than the pressure needed to radially expand the sleeve portion. This has the effect of reducing the pressure difference between the fluid on each side of the rotor and so reducing the force the hydraulic drive system has to overcome to axially move the rotor into the sleeve portion.

The method may comprise the seal in the sleeve portion expanding as the sleeve portion expands under the pressure of the fluid, to maintain the seal between that seal and the sleeve portion.

The method may comprise the step of removing the larger diameter portion and/or the taper portion from the sleeve portion when the sleeve portion has been fitted around the rotor.

In an embodiment in which the sleeve does not comprise the larger diameter portion and optionally the taper portion, there may be no seal other than the seal that seals the first end of the sleeve portion. In this embodiment, fluid that flows between the rotor and the sleeve portion overflows the open end of the sleeve portion, the method comprising this step. In this embodiment, the method may comprise collecting the overflowed fluid in a sump and recirculating this through the hydraulic flow system and optionally introducing this back into the sleeve portion.

In an embodiment in which the pressure of the fluid in the sleeve portion is increased solely by moving the rotor into the sleeve portion towards the first end, the method may comprise controlling the rate at which the rotor is moved such that the pressure of the fluid in the sleeve portion is above the pressure needed to radially expand the sleeve portion to accommodate the rotor and below the pressure at which the sleeve would fail.

The steps may be carried out in the order recited above; they may be carried out in another order; at least some of the steps may be carried out simultaneously. For example, increasing the pressure of the fluid may be carried out before or at the same time as axially moving the rotor. In one embodiment, axially moving the rotor may cause the pressure of the fluid in the sleeve to increase.

According to second aspect of this invention, there is provided apparatus for radially supporting magnets on a rotor of an electrical machine, the apparatus comprising: a sleeve having a sleeve portion; a rotor; and a seal at a first end of the sleeve portion to create a fluid-tight seal at that first end; wherein the rotor is an interference fit within the sleeve portion such that the sleeve portion radially supports magnets on the rotor when it is fitted around the rotor; and wherein the apparatus comprises a quantity of fluid in the sleeve portion, wherein increasing the pressure of the fluid in the sleeve portion causes the sleeve portion to radially expand to thereby accommodate the rotor within the sleeve portion when moved towards the first end.

The apparatus may comprise a taper portion on one or both of the sleeve and the rotor to guide the rotor into the sleeve portion towards the first end when axially moved relative to the sleeve in that direction.

The sleeve may comprise the or a taper portion. The taper portion may be integrally formed with the sleeve portion. The taper portion may taper from a smaller diameter end at the first end of the sleeve portion to a larger diameter end. The larger diameter end may be larger in diameter than the rotor. In this way, the taper portion can act to guide the rotor when moved towards the sleeve portion through the taper portion. The arrangement may be such that when the rotor is axially moved through the taper portion towards the sleeve portion, fluid flows between the outside of the rotor and the inside of the taper portion.

The rotor may comprise a taper portion. The taper portion may taper from the diameter of a body of the rotor to a smaller diameter at an axial end of the rotor. The taper portion of the rotor may be removeable from the rest of the rotor.

The sleeve may comprise a larger diameter portion, radially larger than the sleeve portion. The larger diameter portion may be radially larger than the rotor. The larger diameter portion may be sized to be a clearance fit and/or sliding fit around the rotor. The larger diameter portion may be joined to the second end of the sleeve portion. The taper portion may be provided between the larger diameter portion and the sleeve portion to taper between the larger diameter of the larger diameter portion and the smaller diameter of the smaller diameter portion. The sleeve portion and/or the taper portion and/or the larger diameter portion may be integrally formed.

The fluid may be a liquid. It may be a hydraulic fluid, for example an oil. The fluid may be a gas.

The apparatus may comprise a hydraulic drive system or a mechanical screw drive to axially move the rotor, the system comprising a piston operable under hydraulic pressure to move the rotor. The apparatus may comprise a hydraulic flow system operable to increase the pressure of the fluid in the sleeve portion. The hydraulic flow system may be operable to cause the fluid to flow in-between the rotor and/or the sleeve portion and/or the taper portion and/or the larger diameter portion of the sleeve.

The apparatus may comprise a seal at the end open end of the larger diameter portion furthermost from the first end of the sleeve portion, the seal creating a fluid-tight seal with the larger diameter portion.

The hydraulic flow system may comprise a hydraulic circuit connected to each of the two seals for recirculating fluid through the seal in the sleeve portion, through the sleeve portion, through the tapered portion, through the larger diameter portion, through the seal in the larger diameter portion and back through the hydraulic flow system to recirculate fluid around that path.

The apparatus may comprise a lower-pressure pressure relief valve in fluid communication with the larger diameter portion arranged to relieve the pressure in the larger diameter portion at a pressure higher than atmospheric pressure and below the pressure needed to radially expand the sleeve portion. This has the effect of reducing the pressure difference between the fluid on each side of the rotor and so reducing the force the hydraulic drive system has to overcome to axially move the rotor into the sleeve portion.

The apparatus may comprise a higher-pressure pressure relief value in fluid communication with the sleeve portion arranged to relieve pressure of the fluid in the sleeve portion at a pressure above that at which the sleeve portion radially expands to accommodate the rotor and below that at which the sleeve portion mechanically fails.

The seal in the sleeve portion may be arranged to expand as the sleeve portion expands under the pressure of the fluid to maintain the seal between that seal and the sleeve portion. The seal may be of a resiliently deformable material.

In an embodiment in which the sleeve does not comprise the larger diameter portion and optionally the taper portion, there may be no seal other than the seal that seals the first end of the sleeve portion. In this embodiment, the apparatus comprises a sump for collecting fluid overflowing the sleeve portion for recirculating through the hydraulic flow system and optionally back into the sleeve portion.

In an embodiment, the apparatus may not comprise the hydraulic flow system, the apparatus being arranged such that axial movement of the rotor towards the first end of the sleeve portion increases the pressure of fluid in the sleeve portion and causes fluid to flow from that portion between the rotor and the inside surface of the sleeve portion to exit the sleeve portion.

The sleeve may be formed of composite material. The composite material may comprise carbon fibre.

The, one of or each seal may be fitted to a radially inner surface of the sleeve. The, one of or each seal may be fitted to a radially outer surface of the sleeve. Fitting the seals to radially inner or outer surfaces, rather than the axial edge of the sleeve, provides a greater sealing surface-area and hence a better seal. Fitting the seal to the radially outer surface of the sleeve prevents the seal from blocking the axial movement of the rotor to the first end of the sleeve portion and so the sleeve portion need be no longer than the axial length of the rotor, saving material and a later operation to remove the unnecessary extra length of the sleeve portion.

### BRIEF DESCRIPTION OF THE DRAWINGS

Specific embodiments of the invention will now be described with reference to the accompanying drawings, in which:

FIG. 1 is a schematic sectional view of a first embodiment of apparatus for radially supporting magnets on a rotor of an electrical machine;

FIG. 2 is another schematic sectional view of the first embodiment, showing movement of the rotor and the flow of fluid in the apparatus;

FIG. 3a is a first detailed sectional view of part of the apparatus of the first embodiment showing interaction between the rotor, a sleeve portion and the fluid;

FIG. 3b is a second detailed sectional view of part of the apparatus of the first embodiment showing interaction between the rotor, a sleeve portion and the fluid;

FIG. 3c is a third detailed sectional view of part of the apparatus of the first embodiment showing interaction between the rotor, a sleeve portion and the fluid;

FIG. 4 is another schematic sectional view of the first embodiment, showing the rotor inside the sleeve portion;

FIG. 5 is a schematic sectional view of a second embodiment of apparatus for radially supporting magnets on a rotor of an electrical machine;

FIG. 6a is a first schematic sectional view of a third embodiment of apparatus for radially supporting magnets on a rotor of an electrical machine;

FIG. 6b is a second schematic sectional view of a third embodiment of apparatus for radially supporting magnets on a rotor of an electrical machine;

FIG. 7 is a schematic sectional view of a fourth embodiment of apparatus for radially supporting magnets on a rotor of an electrical machine;

FIG. 8 is a schematic sectional view of a fifth embodiment of apparatus for radially supporting magnets on a rotor of an electrical machine; and

FIGS. 9a, 9b and 9c are schematic sectional views of different sealing arrangements that may be used in some or all of the embodiments of FIG. 1 to FIG. 8.

### DETAILED DESCRIPTION

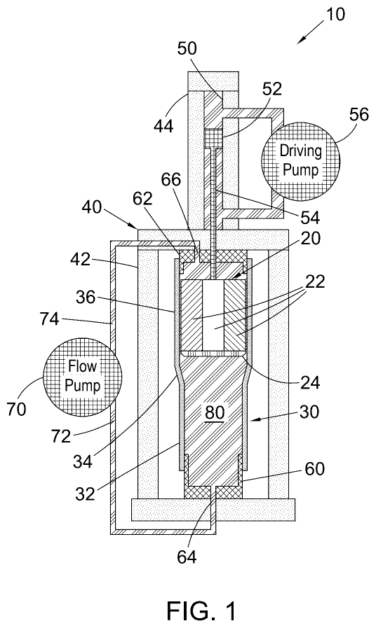

FIG. 1 is a schematic sectional view of a first embodiment of apparatus 10 for radially supporting magnets 22 on a rotor 20 of an electrical machine (not shown). The section of FIG. 1 is taken through a plane extending axially and radially. The apparatus 10 is for use in manufacturing the electrical machine. More specifically, the apparatus 10 is for fitting a sleeve 30 around the outer surface of the rotor 20 to retain the magnets 22 in place on the rotor 20 during use of the electrical machine, by preventing the magnets 22 from becoming displaced as a result of the high forces acting on them at high rotational speeds.

With continued reference to FIG. 1, for the manufacturing operations that will be described, the rotor 20 is positioned in an enclosure 40. The enclosure 40 is made up of a larger cylindrical base part 42 with a smaller cylindrical top part 44 mounted on the base part 42.

The top part 44 defines a hydraulic cylinder 50 in which is mounted a piston 52. A connecting rod 54 extends from the piston 52 into the base part 42 of the enclosure. The cylinder 50 is in flow communication with a drive pump 56 operable to drive the piston 52 by pumping hydraulic fluid. Together, the cylinder 50, piston 52, connecting rod 54 and drive pump 56 make up a hydraulic drive system of the apparatus 10.

The base part 42 of the enclosure 40 contains the rotor 20 and the sleeve 30. With continued reference to FIG. 1, the arrangement of each will now be described in more detail.

The sleeve 30 is made up of a cylindrical sleeve portion 32, a taper portion 34 and a larger-diameter cylindrical portion 36.

The sleeve portion 32 is of an axial length to at least cover the rotor 20 when fitted around the rotor 20 (although, as will be seen, in this embodiment the sleeve portion 32 has to be somewhat longer). The inner diameter of the sleeve portion 32 is less than the outer diameter of the rotor 20, such that, when fitted around the rotor 20, there is an interference fit between the two. (It will be understood that this interference fit will create stress that aids retention of the magnets 22 during use.) A first end of the sleeve portion 32 is positioned lowermost in FIG. 1. The second end of the sleeve portion is joined to the taper portion 34.

The taper portion 34 is a transition from the diameter of the sleeve portion 32 to the larger diameter of the larger diameter portion 36.

The larger diameter portion 36 is sized to have an inner diameter that is larger than the outer diameter of the rotor 20 such that the rotor 20 is a clearance fit inside the larger diameter portion 36. A first end of the larger diameter portion is joined to the taper portion 34. The second end of the larger diameter portion 36 is positioned uppermost in FIG. 1.

The sleeve portion 32, which will surround the magnets 22 of the rotor 20 in use, is formed of a non-magnetic material that will provide the desired retention of the magnets. It is also desirable for the sleeve portion to be as thin as possible to minimise the airgap between the rotor and a stator of the electrical machine. In this embodiment, a carbon-fibre composite is used and it is envisaged that the wall thickness of the sleeve portion be about 0.2 mm or 0.3 mm. Other suitable composites or other non-magnetic materials may be used. The sleeve portion 32, the taper portion 34 and the larger diameter portion 36 of the sleeve 30 are integrally formed together, for example by being formed in an existing way on a mandrel, before being placed in the enclosure 40.

The first end of the sleeve portion 32 is sealed with a seal in the form of a first bung 60. The first bung 60 seals against the inner surface of the sleeve portion 32. The first bung is expandable so that, as will be seen, it can expand with expansion of the sleeve portion and maintain a seal against the sleeve portion as this expansion happens. It is envisaged that the bung may of any suitable material that expands in this way to maintain the seal. In this embodiment it is made of HDPE.

The second end of the larger diameter portion 36 is sealed with a seal in the form of a second bung 62. The second bung seals against the inner surface of the larger diameter portion 36. Although this second bung 62 does not need to expand (as will be seen, the larger diameter portion 36 does not expand during operation of the apparatus 10), it is envisaged it be made of the same material as the first bung 60.

The rotor 20 is axially mounted to the end of the connecting rod 54. At the start of the operation that will be described below, the rotor 20 is positioned inside the larger diameter portion 36 of the sleeve 30 in which the rotor 20 is, as mentioned, a clearance fit. The axial end of the rotor 20 that is remote from the connecting rod 54, this end being lowermost in FIG. 1, has a taper 24 fitted to it that tapers from the diameter of the rotor 20 adjacent the rotor 20 to a smaller diameter away from the rotor 20.

The base part 42 of the enclosure 40 includes a hydraulic flow system in the form of a flow pump 70. An outlet of the pump 70 is connected in fluid communication with the inside of the sleeve portion 32 by a conduit 72 running to an aperture 64 in the first bung 60. An inlet of the flow pump is in fluid communication with the inside of the larger diameter portion 36 of the sleeve 30 by a conduit 74 running to an aperture 66 in the second bung 62.

The apparatus 10 of FIG. 1 also includes fluid in the form of hydraulic oil 80. The oil 80 fills the inside of the sleeve 30, surrounding the rotor 20. It fills also the conduits 72, 74 and the flow pump 70 of the hydraulic flow system. As will be understood from the description that follows, the oil 80 is for radially expanding the sleeve portion 31 of the sleeve so that the rotor 20 can be inserted into and accommodated in the sleeve portion 32. It is envisaged that other suitable fluids may be substituted for the oil 80. For example, water containing rust inhibitors may be used or gas may be used. Using gas would result in the gas diffusing out of the sleeve after manufacturing such that no unnecessary fluid is left on the rotor or other apparatus, reducing or avoiding the need for any subsequent cleaning. and the sleeve.

Operation of the apparatus 10 will now be described.

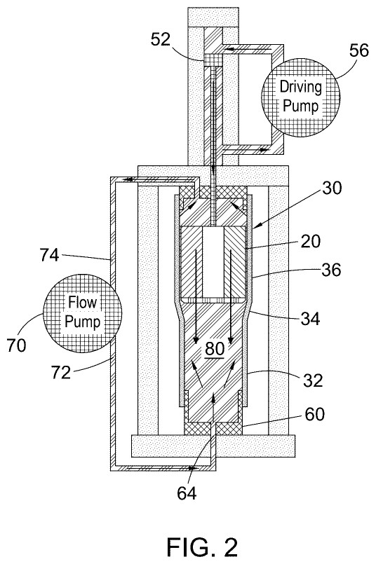

With reference to FIG. 2, the flow pump 70 is operated to pump oil 80 through the conduit 72, through the aperture 64 in the first bung 60 and into the sleeve portion 32 of the sleeve 30. With the rotor 20 positioned as shown in FIG. 2, that is wholly inside the larger diameter portion 36 of the sleeve 30, the oil 80 flows around and over the rotor 20 into the uppermost part of the larger diameter portion 36. From there, the oil 80 flows out through the aperture 74 and back to the flow pump 70. In this way the oil 80 is recirculated. Arrows in FIG. 2 show the direction of the flow of oil 80 just described. As the oil 80 can flow relatively freely at this stage of the operation, due to the gap around the rotor 20 and between the rotor 20 and the larger-diameter portion 36 of the sleeve, the pressure of the oil 80 at all points in relatively low, for example at 1 bar.

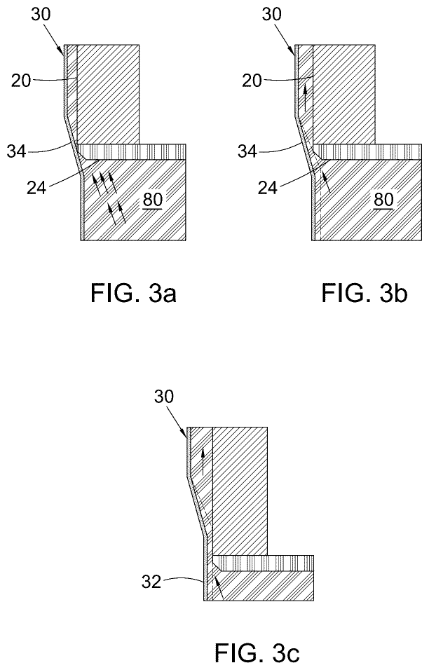

While the oil 80 is flowing in this way and being recirculated, the drive pump 56 is operated, which extends the piston 52, which in turn advances the rotor 20 axially through the larger diameter portion 36 of the sleeve 30 towards the taper portion 34 of the sleeve 30. This continues so that the rotor 20, or more specifically the taper 24 of the rotor 20, comes into contact with the taper 34 of the sleeve 30. This is shown in FIG. 3a.

With continued reference to FIG. 3a, when the taper 24 of the rotor 20 comes into contact with the taper 34 of the sleeve 30, a seal (or at least a partial seal that has the same effect) between the two is formed. As the flow pump 70 continues to operate, the pressure of the oil 80 in the lower-diameter sleeve portion 32 of the sleeve 30 builds and increases, for example to 100 bar.

With reference to FIG. 3b, the increasing pressure of the oil 80 has the effect of radially expanding the taper portion 34 of the sleeve 30 until fluid 80 can again flow around the rotor 20. The flow rate generated by the flow pump 70 is selected or controlled such that the sleeve expands just enough to create a small, self-regulating clearance around the taper 24 of the rotor 20 and a leading edge of the rotor 20. The drive pump 56 continues to operate to build pressure in the cylinder 50. When the resulting force on the piston 52 exceeds the counteracting force on the rotor 20 from the pressure of the oil 80, the rotor 20 again advances, moving through the taper portion 34 of the sleeve 30. As it does this, the already-described expansion of the taper portion 34 continues. In this way, the taper 24 of the rotor, and the leading edge of the rotor 20, are advanced past the taper portion 34 of the sleeve 30.

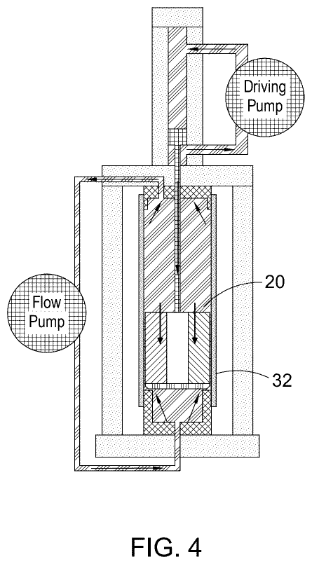

With reference to FIG. 3c, this continues so that the leading edge of the rotor 20 moves into the sleeve portion 32 of the sleeve 30. As before, the operation of the drive pump 70 builds pressure of the oil 80 in the sleeve portion 32 to expand the sleeve portion 32 just enough to create a small clearance around the rotor 20 so that the oil 80 can flow. This clearance is enough to allow the rotor 20 to be advanced, but it is not so much that it would cause the sleeve portion 32 to mechanically fail. The drive pump 56 continues to operate, overcoming the resistive force of the pressurised oil 80 on the rotor, causing the rotor 20 to continue to advance. This continues until the rotor 20 is fully accommodated inside the sleeve portion 32, as is shown in FIG. 4. As mentioned above, the first bung 60 is formed of an expandable material and so expands along with the sleeve portion 32 to maintain the seal between those two components.

Although not shown in the drawings, the manufacturing operation then continues with the rotor 20 being detached from the connecting rod 54 and the taper 24 being removed from the rotor 20. Alternatively, the taper 24 could be part of a rotor endplate and so need not be removed. Next, the rotor 20 with the sleeve 30 fitted around it is removed from the housing 40. The taper portion 34 and the larger diameter portion 36 of the sleeve 30 are then removed to leave the sleeve portion 32 fitted in place around the rotor 20. The rotor 20, with the fitted sleeve portion 32, can then be assembled into the electrical machine (not show).

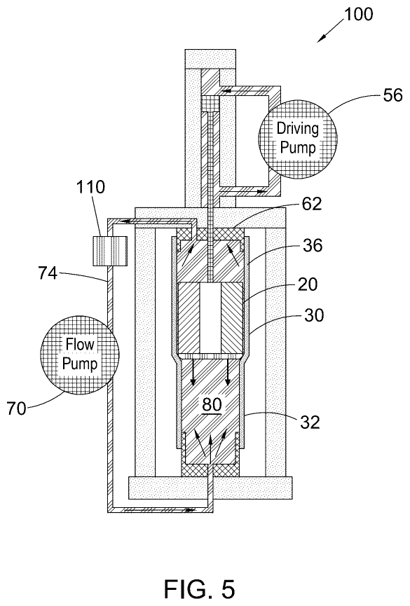

A second embodiment that is a variation of the first embodiment is shown in FIG. 5. The apparatus 100 of the second embodiment is the same as the apparatus 10 of the first embodiment described above with reference to and as shown in FIGS. 1 to 4, with the exception that the apparatus 100 of the second embodiment includes a pressure relief valve 110. Other elements that are common to the two embodiments are referenced in FIG. 5 with the reference numerals used for those same elements in FIGS. 1 to 4.

With continued reference to FIG. 5, the pressure relief valve 110 is positioned in the conduit 74 that connects the second bung 62 at the top of the sleeve 30 to the hydraulic flow pump 70. The purpose of the pressure relief valve 110 is to raise the pressure of the fluid 80 upstream of the valve to a certain, pre-set level. That level is chosen to be below the pressure at which the larger diameter portion 36 of the sleeve would expand (which is expected to be the same as the pressure at which the sleeve portion 32 of the sleeve expands) and significantly above the pressure without the valve 10 in place, for example 50 bar. This is in order to reduce the force needed to advance the rotor 20. It will be appreciated that the pressure of the fluid 80 in the larger diameter portion 36 tends to exert a downward force on the rotor 20 in opposition to the upward force exerted on the rotor 20 by the pressure of the fluid 80 in the sleeve portion 32. Thus, the hydraulic drive pump 56 has less work to do in moving the rotor 20 into the sleeve portion 32 with the pressure relieve valve 110 in place. In this way, the apparatus 100 can operate more efficiently.

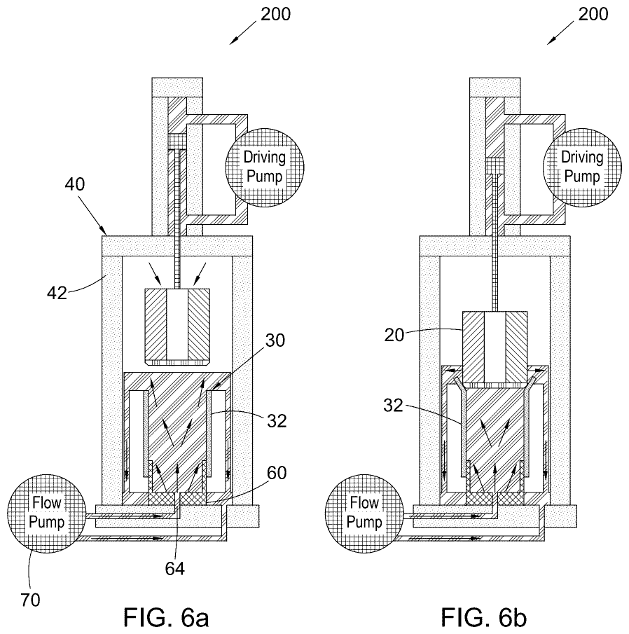

A third embodiment that is a variation of the first embodiment is shown in FIGS. 6a and 6b. Apparatus 200 of the third embodiment is the same as the apparatus 10 of the first embodiment described above with reference to and as shown in FIGS. 1 to 4, with the exception of the modifications set out immediately below.

Again, common elements between this embodiment and the first embodiment keep the same reference numerals.

The apparatus 200 of the third embodiment omits the taper portion 34 and the larger diameter portion 36 of the sleeve 30 of the first embodiment. Thus, only the sleeve portion 32 of the sleeve 30 remains. The apparatus 200 also omits the second bung 62. A further modification is that, in the apparatus 200, the conduit running to the inlet side of the hydraulic flow pump 70 extends from the bottom of the base part 42 of the enclosure 40.

Operation is very similar to that of the first embodiment. However, in this third embodiment, the hydraulic flow pump 70 operates to circulate oil 80, from the inlet aperture 64 in the bung 60 at the first end, through the sleeve portion 32, to overflow the other end of the sleeve portion 32. The overflowing oil is collected at the bottom of the base part 42 of the enclosure 40, which acts as a sump. From there it is drawn back to the flow pump 70 and recirculated.

The drive pump 56 is operated as before to move the rotor 20 towards and through the sleeve portion 32. With reference to FIG. 6b, the taper 24 of the rotor 20 creates a seal against the inside of the sleeve portion 32, which builds oil pressure in the sleeve portion 32 in a similar way as in the first embodiment, resulting in radial expansion of the sleeve portion 32. That expansion allows further advancing of the rotor 20.

By omitting the taper portion 34 and the larger diameter portion 36 from the sleeve 30, the sleeve 30 of this third embodiment is a simple cylinder of constant diameter and so is much easier to manufacture. It also requires less material and does not require the larger diameter section 36 to be removed after the process is complete.

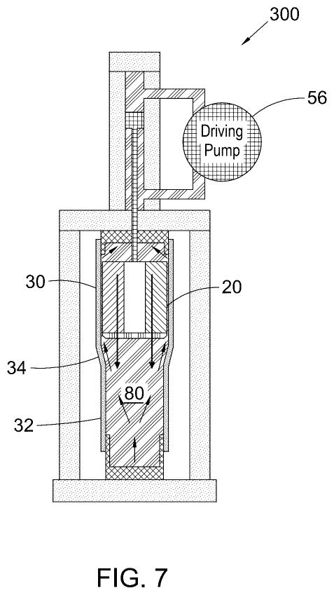

A fourth embodiment that is another variation of the first embodiment is shown in FIG. 7. Apparatus 300 of the fourth embodiment is the same as the apparatus 10 of the first embodiment, with the exception that the hydraulic flow means of the first embodiment are omitted. Thus, the flow pump 70, the two associated conduits 72, 74 and the apertures 64, 66 in the bungs 60, 20 are left out. Again, common elements keep the same reference numerals.

During operation of the apparatus 300 of this fourth embodiment, the drive pump 56 must be operated such that the rotor 20 is advanced quickly enough to generate the necessary pressure in the oil 80 to cause the taper portion 34 and the sleeve portion 32 to expand, and to maintain the necessary oil volumetric flow rate, thereby maintaining the necessary clearance between the sleeve 30 and the rotor to allow for rotor 20 insertion.

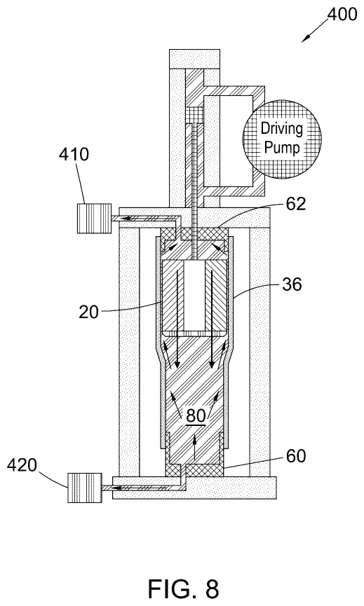

A fifth embodiment that is a variation of the fourth embodiment shown in FIG. 7 is shown in FIG. 8. Common elements keep the same reference numerals. FIG. 8 shows apparatus 400 that is the same as the apparatus 300 of FIG. 7, with the addition of two pressure relief valves 410 and 420. One 410 of the pressure relief valves is connected through an aperture in the second bung 62 to be in fluid communication with oil 80 in the larger diameter portion 36 of the sleeve. This first valve 410 is set at a pressure similar to the valve 110 of the second embodiment described above and with reference to FIG. 5—that is at a pressure that assists advancing of the rotor 20 but does not expand the sleeve 30, for example 50 bar. The other 420 pressure relief valve is connected through an aperture in the first bung 60 to be in fluid communication with oil 80 in the sleeve portion. This second valve 420 is set at a pressure above that at which the oil 80 will expand the sleeve 30 and below that at which the oil 80 will cause the sleeve 30 to mechanically fail, for example 100 bar.

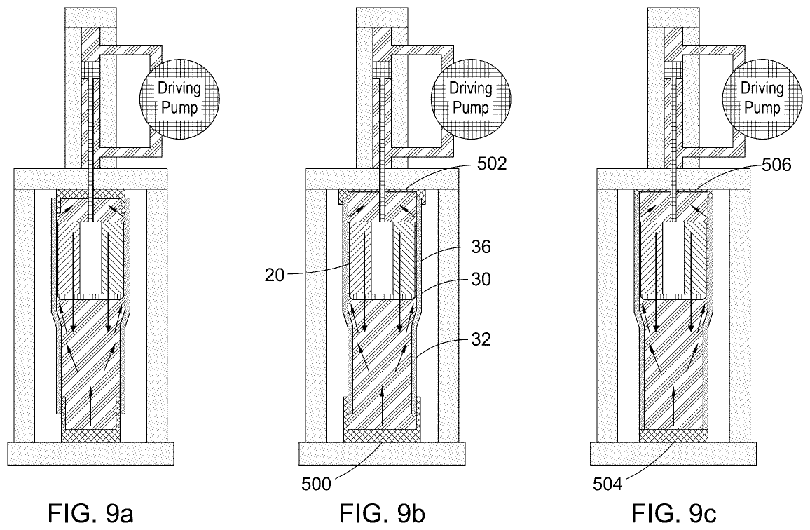

FIGS. 9a, 9b and 9c show different sealing arrangements of the sleeve 30, using different bungs. FIG. 9a shows the arrangement used in the embodiments already described in which the bungs seal against the inside of the sleeve 30.

FIG. 9b shows bungs that seal against the outside of the sleeve 30. Specifically, a first bung 500 that is lowermost seals against the curved outer surface of the first end of the sleeve portion 32 of the sleeve 30. A second bung 502 that is uppermost seals against the curved outer surface of the uppermost end of the larger diameter portion 36 of the sleeve 30. Providing bungs 500, 502 that seal on the outside in this way means that the rotor 20 can be advanced all the way to the end of the sleeve portion 32, allowing the sleeve portion 32 to be made only as long as the axial length of the rotor 20. This saves material.

FIG. 9c shows bungs 504, 506 that seal axially against the first end of the sleeve portion 32 and the uppermost end of the larger diameter portion 506.

Some effects that result from some or all of the embodiments described above are set out below:
It is possible to control the pressure of the fluid, and hence the expansion of the sleeve, by pumping the fluid. The flow rate and viscosity of fluid can be tuned to expand sleeve using a minimal force.
The fluid layer around the rotor and between the rotor and the sleeve allows a controlled and low friction movement between the sleeve and rotor. This results in low axial force required to push rotor into the sleeve and minimal expansion of the sleeve which minimises stress on the sleeve when fitting the rotor.
The sleeve can be initially formed, for example by winding a composite sleeve on a mandrel, with low pre-stress which can increase the process speed of forming the sleeve.
High sleeve pre-tension is achievable by controlling the fit of the sleeve and the rotor.
As the requirement of the sleeve to withstand axial forces is minimised, a thinner sleeve can be used. This reduces the airgap of a machine incorporated the rotor-and-sleeve and also allows for no post machining of the outer surface of the sleeve. This reduces the number of manufacturing steps.
Sealing faces can be on the internal bores which removes the need to accurately machine the carbon fibre sleeve end faces for sealing purposes.
Compared with a plurality of axially-stacked sections of sleeve, there are a reduced number of “end regions” resulting in higher stress in band compared to a multiple sleeve type solution.

1. A method of fitting a sleeve portion around a rotor of an electrical machine to radially support magnets on the rotor in use, the sleeve portion being radially smaller than the rotor before that sleeve portion is fitted around the rotor, the method comprising:
fitting a seal to a first end of the sleeve portion to create a fluid-tight seal between the sleeve portion and that seal;
introducing fluid into the sleeve portion;
axially moving the rotor inside the sleeve portion towards the first end; and
increasing a pressure of the fluid in the sleeve portion to radially expand the sleeve portion and thereby accommodate the rotor within the sleeve portion as it moves towards the first end.

2. The method according to claim 1, wherein increasing the pressure of the fluid in the sleeve portion comprises pumping fluid into the sleeve portion.

3. The method according to claim 1, wherein increasing the pressure of the fluid comprises moving the rotor axially towards the first end to reduce the volume between the rotor and the first end.

4. The method according to claim 1, wherein the method comprises the fluid flowing between the outside of the rotor and the inside of the sleeve portion as the rotor is axially moved inside the sleeve portion towards the first end.

5. The method according to claim 1, wherein the sleeve portion is part of a sleeve that comprises a taper portion, the taper portion tapering from a smaller diameter end at a second end of the sleeve portion to a larger diameter end, larger in diameter than the rotor; the method comprising a step of axially moving the rotor through the taper portion towards the sleeve portion.

6. The method according to claim 5, wherein the fluid flows between the outside of the rotor and the inside of the taper portion as the rotor is axially moved inside the taper portion towards the sleeve portion.

7. The method according to claim 5, wherein the sleeve portion is part of a sleeve that comprises a larger diameter portion, the larger diameter portion extending from the larger diameter end of the taper portion away from the sleeve portion, the larger diameter portion being of larger diameter than the rotor; the method comprising axially moving the rotor inside the larger diameter portion of the sleeve towards the sleeve portion.

8. The method according to claim 1, wherein the method further comprises operating a hydraulic flow system to increase the pressure of the fluid in the sleeve portion above the pressure needed to radially expand the sleeve portion to accommodate the rotor and below the pressure at which at which the sleeve portion would fail; and/or to cause the fluid to flow in-between the rotor and one or more of the sleeve portion, a taper portion and a larger diameter portion of the sleeve.

9. The method according to claim 7, wherein the method further comprises fluid in the larger diameter portion being in fluid communication with a pressure relief valve to maintain the pressure in the larger diameter portion at a pressure higher than atmospheric pressure while keeping it lower than the pressure needed to radially expand the sleeve portion.

10. The method according to claim 1, further comprising the seal in the sleeve portion expanding as the sleeve portion expands under the pressure of the fluid to maintain the seal between that seal and the sleeve portion.

11. The method according to claim 7, further comprising a step of removing the larger diameter portion and/or the taper portion from the sleeve portion when the sleeve portion has been fitted around the rotor.

12. The method according to claim 3, wherein the pressure of the fluid in the sleeve portion is increased solely by moving the rotor into the sleeve portion towards the first end, the method comprising controlling the rate at which the rotor is moved such that the pressure of the fluid in the sleeve portion is above the pressure needed to radially expand the sleeve portion to accommodate the rotor and below the pressure at which at which the sleeve portion would fail.

13. An apparatus for radially supporting magnets on a rotor of an electrical machine, the apparatus comprising:
a sleeve having a sleeve portion;
a rotor; and
a seal at a first end of the sleeve portion to create a fluid-tight seal at that first end;
wherein the rotor is an interference fit within the sleeve portion such that the sleeve portion radially supports magnets on the rotor when it is fitted around the rotor;
and wherein the apparatus comprises a quantity of fluid in the sleeve portion, wherein increasing the pressure of the fluid in the sleeve portion causes the sleeve portion to radially expand to thereby accommodate the rotor within the sleeve portion when moved towards the first end.

14. The apparatus according to claim 13, further comprising a taper portion on the rotor, which optionally is removeable from the rest of the rotor.

15. The apparatus according to claim 13, wherein the sleeve comprises a taper portion, the taper portion tapering from a smaller diameter end at a second end of the sleeve portion to a larger diameter end, the larger diameter end being larger in diameter than the rotor, the arrangement such that when the rotor is axially moved through the taper portion towards the sleeve portion, fluid flows between the outside of the rotor and the inside of the taper portion.

16. The apparatus according to claim 13, wherein the sleeve comprises a larger diameter portion, radially larger than the sleeve portion and radially larger than the rotor, optionally wherein a taper portion is provided between the larger diameter portion and the sleeve portion to taper between the larger diameter of the larger diameter portion and a smaller diameter of the sleeve portion.

17. The apparatus according to claim 13, wherein the apparatus comprises a hydraulic flow system operable to increase the pressure of the fluid in the sleeve portion, optionally wherein the hydraulic flow system is operable to cause the fluid to flow between the rotor and/or the sleeve portion and/or a taper portion and/or a larger diameter portion of the sleeve.

18. The apparatus according to claim 15, wherein the apparatus comprises a lower-pressure pressure relief valve in fluid communication with the larger diameter portion and arranged to relieve the pressure in the larger diameter portion at a pressure higher than atmospheric pressure and below the pressure needed to radially expand the sleeve portion.

19. The apparatus according to claim 13, wherein the apparatus comprises a higher-pressure pressure relief value in fluid communication with the sleeve portion and arranged to relieve pressure of the fluid in the sleeve portion at a pressure above that at which the sleeve portion radially expands to accommodate the rotor and below that at which the sleeve portion mechanically fails.

20. The apparatus according to claim 13, wherein the seal in the sleeve portion is arranged to expand as the sleeve portion expands under the pressure of the fluid to maintain the seal between that seal and the sleeve portion.
